(19) United States
(12) Patent Application Publication
(10) Pub. No.: US 2022/0234446 A1
(43) Pub. Date: Jul. 28, 2022

(54) Vehicle Digital Display Device

(71) Applicant: Merdan Nazarov, Cranberry Township, PA (US)

(72) Inventor: Merdan Nazarov, Cranberry Township, PA (US)

(21) Appl. No.: 17/583,288

(22) Filed: Jan. 25, 2022

Related U.S. Application Data
(60) Provisional application No. 63/142,161, filed on Jan. 27, 2021.

(51) Int. Cl. B60K 35/00; B60R 13/10

(52) U.S. Cl. CPC B60K 35/00; B60R 13/105; B60K 2370/1438; B60K 2370/165; B60K 2370/797; B60K 2370/5911; B60K 2370/67; B60K 2370/693; B60K 2370/816; B60K 2370/573

(57) ABSTRACT

The present invention relates to a digital display device for mounting to a vehicle's front bumper. The device is used for customizing an exterior of the vehicle by displaying images, videos and messages as per the preference of the vehicle owner or driver. The display device is configured to connect to a computer implemented software application using a wireless channel for receiving one or more images, videos, or messages (collectively media) for display. The application enables users to subscribe to purchase media by making a payment and transmitting purchased media to the display device for displaying on the vehicle's exterior. The display device can also be configured to display a license plate number of the vehicle.

### CROSS-REFERENCE TO RELATED APPLICATION

The present application claims priority to, and the benefit of, U.S. Provisional Application No. 63/142,161, which was filed on Jan. 27, 2021 and is incorporated herein by reference in its entirety.

### FIELD OF THE INVENTION

The present invention relates generally to the field of vehicle customization systems and devices. More specifically, the invention relates to a vehicle exterior mounted digital display device and a system and method of temporarily customizing the exterior of the vehicle using the digital display device. The invention offers a simple way to customize the look of a vehicle without making excessive and permanent modifications. Accordingly, the present disclosure makes specific reference thereto. Nonetheless, it is to be appreciated that aspects of the present invention are also equally applicable to other like applications, devices and methods of manufacture.

### BACKGROUND

By way of background, vehicle owners like to “customize” their vehicles in order to give each vehicle a unique appearance that reflects the personality and interests of the vehicle owner. One of the easiest ways to change the look of the vehicle is to change its exterior. However, current methods of customization require permanent changes to the exterior of the vehicle, such as change in the paint of the vehicle, replacing existing lamps and other vehicle body parts, or placing vinyl stickers on the vehicle, for example. The available methods are not just permanent but are also expensive and time consuming.

Moreover, current ways of customization provide a static and permanent look to the vehicle which may prohibit vehicle owners and drivers to pursue customization again in the near future. This leads to low performance of the vehicle and a decrease in resale value.

Metal fixed license plates, and even digital (i.e. digital screen) license plates, are static and do not allow any other image or video to be displayed on the plate or digital screen. Individuals desire enhanced screens that can display images, videos, and/or messages in addition to the license plate numbers.

Individuals desire a customization method and device for their vehicles that is not only temporary and efficient, but is also cost-effective. Further, individuals desire a do-it-yourself method for changing and customizing their vehicle, thereby eliminating the expensive process of going to a car customization service provider.

Therefore, there exists a long felt need in the art for a vehicle customization method that is temporary, efficient and cost-effective. There is also a long felt need in the art for a vehicle customization device that provides a unique and personalized look to the vehicle. Additionally, there is a long felt need in the art for a device that can be used in place of front license plates to give a more aesthetic look to the vehicle. Moreover, there is a long felt need in the art for a vehicle customization method that enables users to independently customize the exterior of their vehicle. Further, there is a long felt need in the art for a vehicle customization device that can display personalized videos, messages, and/or images on the exterior of the vehicle as per the preference of the vehicle owner or driver. Finally, there is a long felt need in the art for a customization device for the vehicle's exterior that offers a simple way to customize the look of a vehicle without necessitating excessive and permanent modifications.

The subject matter disclosed and claimed herein, in one embodiment thereof, comprises a digital display device for mounting to a vehicle's exterior. The digital display device is configured to display images, videos, and/or messages for customizing the look of the vehicle. The device is a part of a customization system and includes a digital screen for displaying one or more of an image, a video and a message. The device includes a mechanical fastener on a surface opposite to the digital screen for mounting the device to the exterior of the vehicle, a wireless module for establishing a wireless channel with a nearby handheld electronic device, a push button for activating or deactivating the device, a battery for providing power to the digital screen, and a USB port for receiving power for recharging the battery. The device is further configured to receive images, videos, and/or messages from the handheld electronic device with which the wireless connection is established for displaying on the digital screen wherein a smartphone application installed in the electronic device transmits and edits images, pictures, videos, and/or messages through the established wireless channel.

In this manner, the digital display device of the present invention accomplishes all of the forgoing objectives and provides users with a digital display device for installation on the vehicle's exterior that is capable of communicating wirelessly with a smartphone application for receiving images, videos and/or messages for display. The display device is a part of a customization system that involves the smartphone application. Users can subscribe to purchase images, videos and messages for displaying on the digital display device.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a digital display device for mounting to a vehicle's exterior. The digital display device is configured to display images, videos and messages for customizing the look of the vehicle. The device further comprising a digital screen for displaying one or more of an image, a video or a message, a mechanical fastener on a surface opposite to the digital screen for mounting the device to the exterior of the vehicle, a wireless module for establishing a wireless channel with a nearby handheld electronic device, a push button for activating or deactivating the device, a battery for providing power to the digital screen and a USB port for receiving power for recharging the battery. The device is further configured to receive images, videos, or messages from the handheld electronic device with which the wireless connection is established for displaying on the digital screen wherein a smartphone application installed in the electronic device transmits and edits images, videos, and/or messages through the established wireless channel.

In yet another embodiment, the digital display device includes a transparent protective cover for protecting the digital screen therebehind.

In yet another embodiment, the digital display device includes a built-in memory for storing one or more images, videos, and messages.

In yet another embodiment, the digital screen is one or more of LCD, LED, TFT and OLED.

In yet another embodiment, the digital display device includes a non-displaying bezel.

In yet another embodiment, the digital display device is bezel-less.

In yet another embodiment, a system for customizing an exterior of a vehicle is disclosed. The system includes a digital display device mounted on front of the vehicle, a computer implemented application installed in an electronic device and a storage server, the digital display device is configured to display at least one image, picture, video or message for customizing the exterior of the vehicle, the at least one image, picture, video, or message is received by the digital device from the computer implemented application wherein the application downloads the at least one image, picture, video, or message from the storage server.

In yet another embodiment of the present invention, a computer implemented method for customizing an exterior of a vehicle without any permanent and expensive customization is described. The method includes the steps of pairing, using a wireless communication channel, a digital device installed on the exterior of a vehicle and a computer implemented smartphone application, downloading on the smartphone application, a plurality of images, pictures, videos and/or messages from a storage server, receiving, by the smartphone application, a selection of at least one image, picture, video or message, then transmitting by the smartphone application to the digital device the selected image, picture, video or message and displaying, by the digital device, the selected image, picture, video or message for customizing the exterior of the vehicle.

In yet another embodiment, the method includes the step of receiving, by the smartphone application, a license plate number.

In yet another embodiment, the method includes the step of downloading the smartphone application from an application play store.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the vehicle mounted digital display device of the present invention in accordance with the disclosed architecture;

FIG. 2 illustrates a perspective view of a vehicle with the digital display device of the present invention installed on the front bumper in accordance with the disclosed architecture;

FIG. 3 illustrates a schematic view showing the connection of the display device and a computer implemented application installed in a handheld electronic device in accordance with the disclosed architecture;

FIG. 4 illustrates an exemplary user interface of the computer implemented application showing various options to a user for subscribing and operating the digital display device of the present invention in accordance with the disclosed architecture;

FIG. 5 illustrates an exemplary interface of the computer implemented application displaying various plans offered to a user for downloading and displaying media on the digital device of the present invention in accordance with the disclosed architecture; and

FIG. 6 illustrates a flow diagram showing exemplary steps performed in the use of the digital device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a vehicle customization method that is temporary, efficient, and cost-effective. There is also a long felt need in the art for a vehicle customization device that provides a unique and personalized look to the vehicle. Additionally, there is a long felt need in the art for a device that can be used in place of front license plates to give a more aesthetic look to the vehicle. Moreover, there is a long felt need in the art for a vehicle customization method that enables users to independently customize the exterior of their vehicle. Further, there is a long felt need in the art for a vehicle customization device that can display personalized videos, messages, and/or images on the exterior of the vehicle as per the preference of the vehicle owner or driver. Finally, there is a long felt need in the art for a customization device for the vehicle's exterior that offers a simple way to customize the look of a vehicle without necessitating excessive and permanent modifications.

The present invention, in one exemplary embodiment, is a novel computer implemented method for customizing an exterior of a vehicle without any permanent and expensive customization. The method includes the steps of pairing, using a wireless communication channel, a digital device installed on the exterior of a vehicle and a computer implemented smartphone application, downloading on the smartphone application, a plurality of images, videos and messages from a storage server, receiving by the smartphone application, a selection of at least one image, picture, video or message, then transmitting by the smartphone application to the digital device the selected image, picture, video or message and displaying, by the digital device, the selected image, picture, video, or message for customizing exterior of the vehicle.

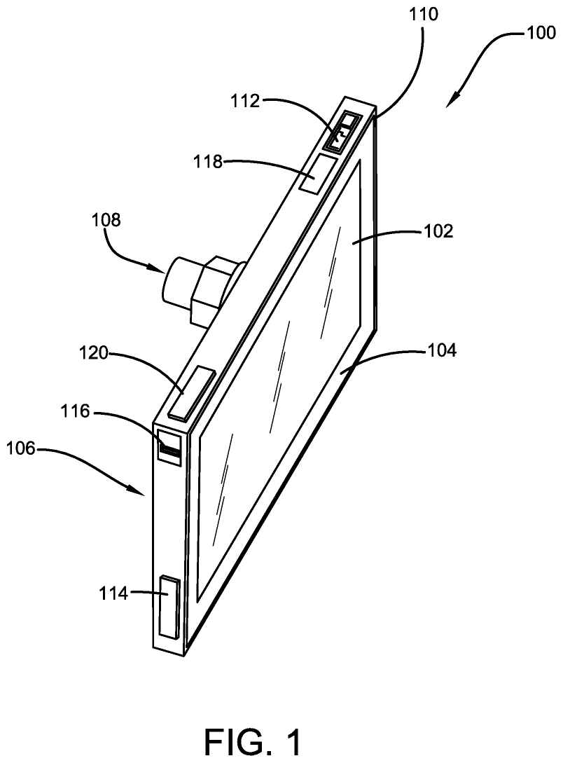

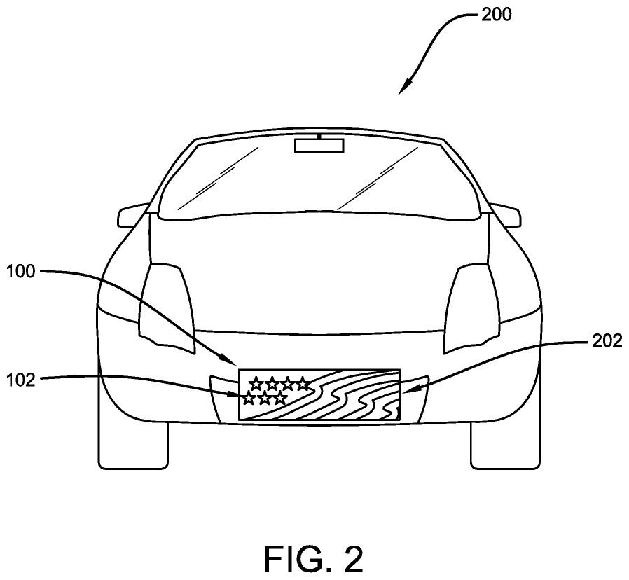

Referring initially to the drawings, FIG. 1 illustrates a perspective view of the vehicle mounted digital display device of the present invention in accordance with the disclosed architecture. The digital display device 100 of the present invention is configured to be removably mounted to a vehicle's front bumper or proximal thereto. The display device 100 has a digital screen 102 that is configured to display images, messages, videos and/or other media and thus enabling a simple way to customize the look of the vehicle without making excessive and permanent modifications. The screen 102, in one exemplary configuration, can be a digital screen from about 4″ to about 8″ in height and from about 12″ to about 18″ in width, surrounded by a non-display bezel frame 104. The device 100 in some embodiments can be a bezel-less device. The rear surface 106 of the digital display device 100 includes one or more mechanical fasteners 108 that are used for removably mounting the device 100 onto the vehicle's front bumper as shown in FIG. 2.

The digital screen 102 can be one of the LCD, LED, TFT, OLED or other display devices and can be a flexible display. The digital screen 102 can be a touch sensitive or touchless screen. The digital device 100 includes a protective transparent cover 110 made from plastic to protect the digital screen 102 from weather elements and physical damage. The device 100, including the screen 102, is designed to be weatherproof and capable of handling high temperatures up to 60 degrees C. and low temperatures down to −20 degrees C. The digital device 100 includes a power button 112 used for manually activating or deactivating the device 100. Further, the device 100 includes an integrated battery 114 that can be recharged using a USB power port 116. Any conventional USB charging cable can be used for recharging the integrated battery 114. The battery 114 is primarily used for providing electric power to the display screen 102. Alternatively, or in conjunction with the integrated battery 114, the display device 100 can be powered by the vehicle battery.

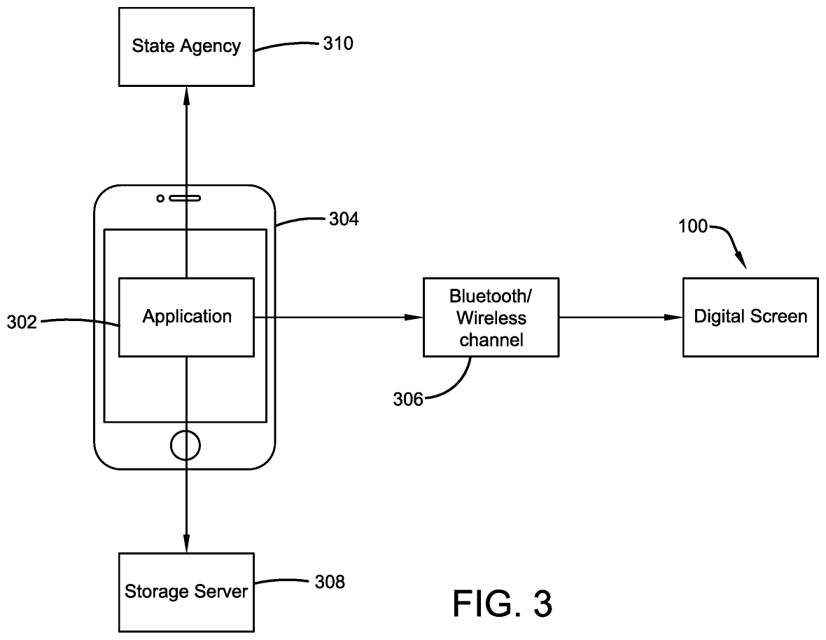

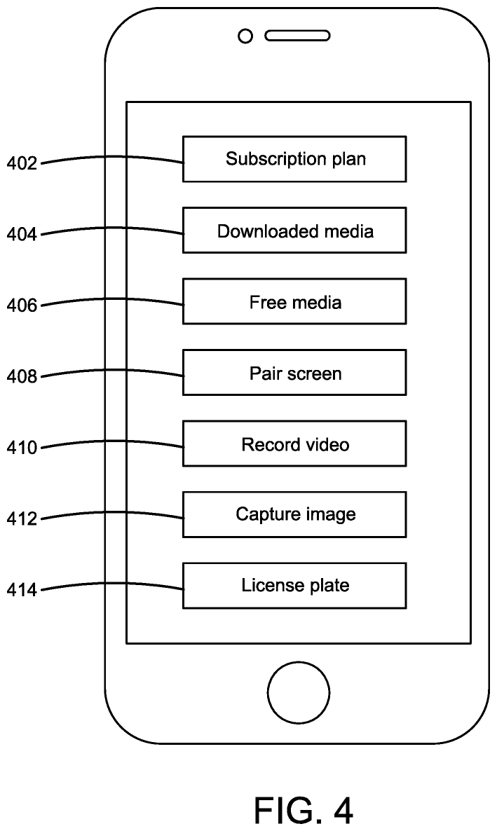

The digital display device 100 includes a built-in memory 118, for example, a hard disk drive (HDD), a flash memory or a ROM and is used for storing a default image, message, or video (collectively referred to as media). The stored media is displayed on the screen 102 when the device 100 is activated using the power button 112. The default media can be replaced by another media selected by a user on a handheld electronic device as best described in FIGS. 3 and 4. The device 100 is designed to be controlled using a computer implemented application installed in the handheld electronic device as shown in FIG. 3. The media can be selected in the computer implemented application for display on the display screen 102 to customize the look of a vehicle on which the display device 100 is mounted without making excessive and permanent modifications. Further, the media selected on the computer implemented application replaces the default media played on the screen 102. A wireless channel for establishing wireless communication between the digital display device 100 and the handheld electronic device is established using the built-in wireless module 120 of the device 100.

FIG. 2 illustrates a perspective view of a vehicle with the digital display device 100 of the present invention installed on the front bumper in accordance with the disclosed architecture. The device 100 is configured to attach to the front bumper 202 of the vehicle 200 such as car, truck, bus, SUV and more. It should be understood that the device 100 can be mounted to the rear bumper of the vehicle 200 as well, to customize the look of the vehicle 200. The mechanical fasteners 108 are used for mounting the device 100 on the front bumper 202 such that the display screen 102 is visually exposed. An image, picture, video, or message displayed on the screen 102 can be changed by a user and therefore customizes the appearance of the exterior of the vehicle 200 without any permanent and expensive customization.

The power button 112 is accessible to a user while the display device 100 is mounted to the front bumper 202 so that the user can manually activate/deactivate the display device 100.

FIG. 3 illustrates a schematic view 300 showing the connection of the display device 100 and a computer implemented application 302 installed in a handheld electronic device 304 in accordance with the disclosed architecture. The display device 100 is configured to wirelessly connect to the computer implemented smartphone application 302 installed on an electronic device or smartphone 304 using the wireless communication channel 306. The display device 100 can also be activated/deactivated by the smartphone application 302. The wireless communication channel 306 can be a low energy Bluetooth connection. Using the wireless channel 306, the application 302 is designed to transmit a media to display on the display screen 102 of the digital device 100. The application 302 can also adjust a brightness (i.e. night or day mode) of the display screen 102. A driver or user of the vehicle can select a media to display on the screen 102 wherein the media are displayed in the application 302. For example, a driver (i.e. independent contractor) can select a media message to identify that the vehicle is a ridesharing transportation vehicle and also display the first name identity of the person that the driver is there to pick-up.

The application 302 is connected to a storage server 308 which can be a cloud storage server or a distributed server, preferably of a service provider providing media for display on the display device 100. A user of the application 302 can subscribe to download media from the storage server to the application 302 and a media from the application 302 can be selected by the user to display on the display screen 102 for customization of the vehicle to which the display device 100 is mounted. The storage server 308 is configured to provide free images, videos and messages (media) to a user of the application 302 and also provides subscribed or paid media to the user.

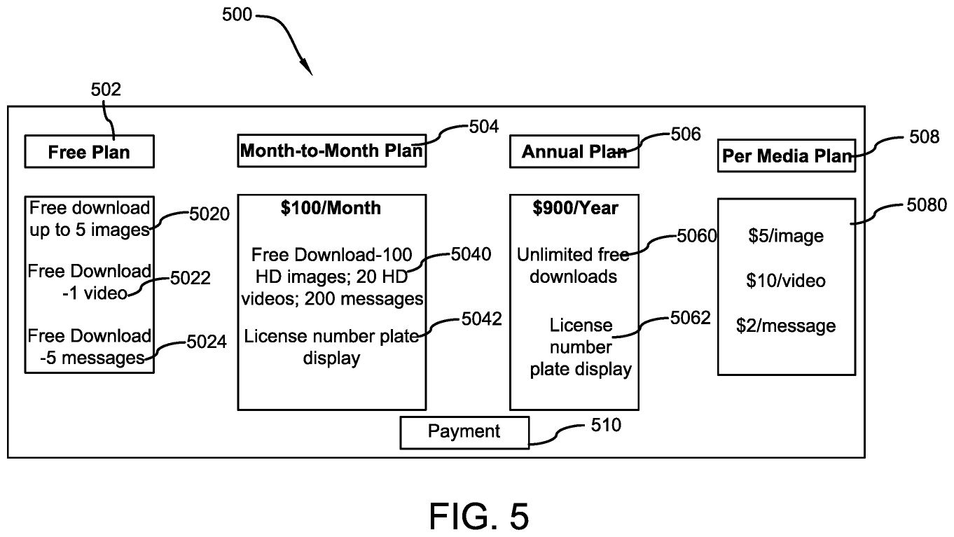

The application 302 is also designed to communicate with a state agency 310 for monitoring purposes. This enables the application 302 to communicate license plate number of the vehicle to which the display device 100 is mounted to the state agency 310. Based on successful registration of the license plate number with the state agency 310, a user can also display the digital license plate number on the display screen 102 of the display device 100. It should be understood that displaying of the license plate on the screen 102 can be available in a subscription plan, rather than a free service plan (as shown in FIG. 5).

FIG. 4 illustrates an exemplary user interface 400 of the application 302 showing various options to a user for subscribing and operating the digital display device 100 of the present invention in accordance with the disclosed architecture. As shown, the subscription plan header 402 provides the details of the subscription plan (referring to FIG. 5, i.e. a free plan, a month-to-month plan, an annual plan or a per media plan). The subscription plan can be updated by the user based on the preferences of the user. The downloaded media header 404 displays the images, videos and messages downloaded from the storage server by the user. Any downloaded media can be selected by the user for displaying on the digital screen 102.

The free media header 406 provides the free media provided to a user when the user downloads the application 302 from an application play store. The free media is limited in number as best shown in FIG. 5. The pair screen header 406 is used for pairing the application 302 with a digital device 100. The pairing can be done using a Bluetooth connection with the handheld electronic device in which the application 302 is installed discovering the digital device 100. Other means such as using Wi-Fi Direct to use a service set identifier (SSID) of the device 100 can be used for pairing the device 100 and the application 302.

One advantage of the display device 100 and the smartphone application 302 is that a user can record a video using a camera of the electronic device 304 upon clicking the record video header 410 and transmit same to the device 100 for displaying on the screen 102. Similarly, an image can be captured using the capture image header 412 and the image can be displayed on the screen 102. For displaying the license plate number on the digital display 414, the license plate header 414 can used by the user. The registered license plate number of the vehicle can be displayed on the screen 102 and a notification can be transmitted to a state agency for monitoring purposes.

The user can create a playlist having a mix of one or more of an image, a video and a message to display on the digital screen 102 in a rolling manner. The playlist can be transmitted continuously to the digital device 100 from the application 302.

FIG. 5 illustrates an exemplary interface 500 of the computer implemented application 302 displaying various plans offered to a user for downloading and displaying media on the digital device of the present invention in accordance with the disclosed architecture. As shown, the free plan 502 is offered to any user who purchased the digital device 100 and registered on the application 302. The free plan 502 can include, for example, free download of five images 5020, a free download of one video 5022, and a free download of five messages 5024.

The month-to-month plan 504 can include, for example, a monthly cost of $100 per month and a user can download up to a hundred HD images, twenty HD videos and two hundred messages as referred by numeral 5040. The month-to-month plan 504 can also provide the capability of displaying license number plate 5042 on the digital screen 102.

The annual plan 506 can include, for example an annual cost of $900 each year for providing savings to a user relative to the monthly plan. A user can download unlimited media 5060. The annual plan 506 can also provide the capability of displaying license number plate 5062 on the digital screen 102.

A per media plan 508 can include, for example a charging or cost method that enables a user to purchase a single media as per the preference of the user. In the per media plan 508, the user can purchase, for example, an image for five dollars, a video for ten dollars, and/or a single message for two dollars referred collectively as reference 5080.

The user interface 500 provides a payment header 510 that enables a user to subscribe to a desired plan by a specified payment plan.

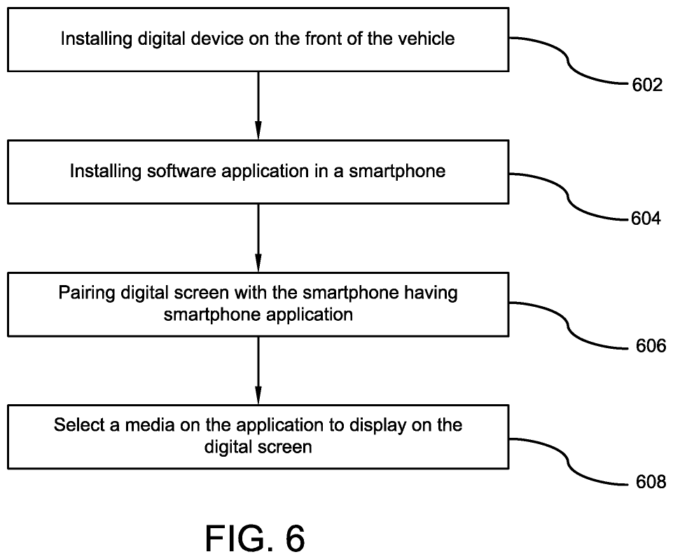

FIG. 6 illustrates a flow diagram showing exemplary steps performed in use of the digital device 100 of the present invention in accordance with the disclosed architecture. As shown, initially, digital device 100 is installed on an exterior of the vehicle, for example in front of the vehicle using the mechanical fasteners (Step 602). Thereafter, the software application 302 can be installed in the electronic device from an application play store (Step 604). Then, the application can be paired with the digital device 100 (Step 606). Finally, the user can select at least one media in the smartphone application for displaying on the digital screen 102 of the device 100 (Step 608).

The digital device 100 is configured to display video in MP4, MOV, AVI, WMV, HTML5 or other formats. Further, the digital device 100 can be configured to display images in JPEG, PNG, SVG, GIF, TIFF and other formats.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “digital display device”, “display device”, “device” and “digital device” are interchangeable and refer to the digital display device 100 of the present invention.

Notwithstanding the forgoing, the digital display device 100 of the present invention can be of any suitable size and configuration as is known in the art without affecting the overall concept of the invention, provided that it accomplishes the above-stated objectives. One of ordinary skill in the art will appreciate that the digital display device 100 as shown in the FIGS. are for illustrative purposes only, and that many other sizes and shapes of the digital display device 100 are well within the scope of the present disclosure. Although the dimensions of the digital display device 100 are important design parameters for user convenience, the digital display device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A display device for mounting on a vehicle, the display device comprising:
a digital screen configured to display a plurality of electronic images, wherein said display device is removably mounted to the vehicle and said plurality of electronic images is selected from a media comprised of an image, a message and a video; and
a wireless channel for establishing a wireless communication between said display device and a handheld electronic device, wherein said media is selectable by a user on said handheld electronic device, and further wherein said handheld electronic device comprises a computer implemented application for selecting said media.

2. The display device of claim 1, wherein said digital screen is selected from a group consisting of an LCD, an LED, a TFT and an OLED display screen.

3. The display device of claim 2, wherein said digital screen is from about 4 inches to about 8 inches in height and from about 12 inches to about 18 inches in width.

4. The display device of claim 3, wherein said digital screen is a touch sensitive screen.

5. The display device of claim 1, further comprising a bezel frame surrounding said digital screen, wherein a rear surface of said bezel frame includes at least one mechanical fastener for removably mounting said display device to the vehicle.

6. The display device of claim 5, further comprising a plastic protective and transparent cover for protecting said digital screen from an element.

7. The display device of claim 6, wherein said display device is weatherproof.

8. The display device of claim 7, further comprising a power button for manually activating and deactivating said display device.

9. The display device of claim 8, further comprising a battery.

10. The display device of claim 1, wherein said media is changeable by the user for customizing said plurality of electronic images.

11. The display device of claim 10, wherein said media comprises a ridesharing identifier.

12. The display device of claim 10, wherein said media comprises a license plate number.

13. A display device removably mounted on a vehicle, the display device comprising:
a digital screen;
a media comprising a plurality of electronic images, wherein the media is in communication with the digital screen and the plurality of electronic images comprise an image, a message and a video;
a wireless channel for establishing a wireless communication between said display device and a handheld electronic device, wherein said media is selectable by a user on said handheld electronic device, and further wherein said handheld electronic device comprises a computer implemented application for selecting said media; and
a service provider including a storage server providing said media to said handheld electronic device.

14. The display device of claim 13, wherein said service provider includes a subscription for providing said media.

15. The display device of claim 14, wherein said media is changeable by the user for customizing said plurality of electronic images.

16. The display device of claim 13, wherein said media comprises a ridesharing identifier.

17. The display device of claim 14, wherein said media comprises a license plate number.

18. A method for displaying an electronic media on a vehicle, the method comprising the steps of:
mounting a digital display device on the vehicle, wherein said display device comprises a digital screen configured to display a plurality of electronic images, wherein said plurality of electronic images are selected from a media comprised of an image, a message and a video;
establishing a wireless communication between said display device and a handheld electronic device;
selecting said media by a user on said handheld electronic device, wherein said handheld electronic device comprises a computer implemented application for selecting said media; and
transmitting said media to said display device.

19. The method of claim 18, further comprising a step of subscribing to a service provider for providing said media to said handheld electronic device.

20. The method of claim 19, wherein said media is changeable by the user for customizing said plurality of electronic images.
